(19) United States
(12) Patent Application Publication
(10) Pub. No.: US 2020/0026560 A1
(43) Pub. Date: Jan. 23, 2020

(54) DYNAMIC WORKLOAD CLASSIFICATION FOR WORKLOAD-BASED RESOURCE ALLOCATION

(71) Applicant: Nutanix, Inc., San Jose, CA (US)

(72) Inventors: Amit B. SINGH, Milpitas, CA (US); Anirban ROY, Sunnyvale, CA (US); Kranti Surya YADHATI, Fremont, CA (US); Muthukumar SUBRAMANIAN, Fremont, CA (US)

(73) Assignee: Nutanix, Inc., San Jose, CA (US)

(21) Appl. No.: 15/418,529

(22) Filed: Jan. 27, 2017

(51) Int. Cl. G06F 9/50

(52) U.S. Cl. CPC G06F 9/5005; G06F 9/5083; G06F 9/5077

(57) ABSTRACT

Techniques for managing virtualized entities in computing systems. In a method embodiment, processing commences upon receiving I/O activity trace data associated with virtualized entities running in a computing system. Specific I/O activity attributes are extracted from the I/O activity trace data, and the I/O activity attributes are used to form a workload classification model. The workload classification model serves to assign one or more workload classifications to a respective one or more observed workloads running on the computing system. Based on the determined workload classification or classifications, recommended resource allocation operations are formed for further consideration. Considered resource allocation operations include migrations of virtualized entities from a source computing resource to a target computing resource. Consideration of the resource allocation operations include considering homogeneity of workloads at a target computing resource and/or matching specific workload resource demands to availability of specific types of resources at a candidate target computing resource.

This disclosure relates to distributed resource system management, and more particularly to techniques for distributed resource allocation using dynamically classified workloads.

### BACKGROUND

The resource usage efficiencies offered by distributed computing and storage systems has resulted in continually increasing deployment of such systems. In a distributed computing and storage system, certain components having certain resource demands (e.g., computing cycle demands) can be coordinated to efficiently use a particular set of computational or compute resources, while certain other components having certain other resource demands (e.g., data storage I/O (input/output or IO) demands) can coordinate to efficiently use a particular set of data storage resources or facilities.

Unfortunately, legacy techniques for managing resources in distributed virtualization systems fail to achieve the best results. Whereas in many computing systems there are many choices for assigning resource demands to resource availability, legacy techniques fail to recognize multi-faceted (e.g., CPU demand, storage I/O demand, network bandwidth demand, etc.) aspects of an allocable entity (e.g., a workload), resulting in sub-optimal initial resource allocations or subsequent reallocations.

What is needed is a technique or techniques to improve over legacy techniques and/or over other considered approaches. Some of the approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

The present disclosure provides a detailed description of techniques used in systems, methods, and in computer program products for distributed resource allocation using dynamically classified workloads, which techniques advance the relevant technologies to address technological issues with legacy approaches. More specifically, the present disclosure provides a detailed description of techniques used in systems, methods, and in computer program products for distributed resource allocation using dynamically classified workloads. Certain embodiments are directed to technological solutions for implementing a workload detection and classification model to dynamically classify workloads so as to facilitate workload-based resource allocation in a distributed virtualization system.

The disclosed embodiments modify and improve over legacy approaches. In particular, the herein-disclosed techniques provide technical solutions that address the technical problems attendant to considering workload-based constraints when dynamically allocating resources in a distributed virtualization system. Such technical solutions relate to improvements in computer functionality. Various applications of the herein-disclosed improvements in computer functionality serve to reduce the demand for computer memory, reduce the demand for computer processing power, reduce network bandwidth use, and reduce the demand for inter-component communication. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of hyperconverged computing platform management as well as advances in various technical fields related to high-performance data storage.

Further details of aspects, objectives, and advantages of the technological embodiments are described herein and in the drawings and claims.

### BRIEF DESCRIPTION OF THE DRAWINGS

The drawings described below are for illustration purposes only. The drawings are not intended to limit the scope of the present disclosure.

FIG. 1A presents a workload affinity determination technique, according to an embodiment.

FIG. 1B presents a workload-based resource allocation technique using dynamically classified workloads, according to an embodiment.

FIG. 1C depicts a set of techniques used when performing distributed resource allocation using dynamically classified workloads, according to some embodiments.

FIG. 2 depicts a distributed virtualization environment in which embodiments of the present disclosure can operate.

FIG. 3A1 presents a workload classification model generation technique as implemented in systems for distributed resource allocation using dynamically classified workloads, according to an embodiment.

FIG. 3A2 presents a workload detection model generation techniques as implemented in systems for distributed resource allocation using dynamically classified workloads, according to an embodiment.

FIG. 3B presents a workload classification technique as implemented in systems for distributed resource allocation using dynamically classified workloads, according to an embodiment.

FIG. 4A presents a workload consolidation technique as implemented in systems for distributed resource allocation using dynamically classified workloads, according to some embodiments.

FIG. 4B presents a workload firewalling technique as implemented in systems for distributed resource allocation using dynamically classified workloads, according to some embodiments.

FIG. 4C presents a workload prioritization technique as implemented in systems for distributed resource allocation using dynamically classified workloads, according to some embodiments.

FIG. 4D presents a workload analysis technique as implemented in systems for distributed resource allocation using dynamically classified workloads, according to some embodiments.

FIG. 5 depicts system components as arrangements of computing modules that are interconnected so as to implement certain of the herein-disclosed embodiments.

FIG. 6A and FIG. 6B depict virtualized controller architectures comprising collections of interconnected components suitable for implementing embodiments of the present disclosure and/or for use in the herein-described environments.

### DETAILED DESCRIPTION

Embodiments in accordance with the present disclosure address problems encountered when dynamically allocating resources in a distributed virtualization system. Some embodiments are directed to approaches for implementing a workload detection and classification model to dynamically detect and classify workloads so as to facilitate highly-reliable workload-based resource allocations. The accompanying figures and discussions herein present example environments, systems, methods, and computer program products for distributed resource allocation using dynamically classified workloads.

### Virtualized System Overview

Distributed systems that support virtualized entities (VEs) are often referred to as distributed virtualization systems. In some cases, a distributed virtualization system might include virtualized entities in the form of virtual machines (VMs). Such VMs can be characterized as software-based computing “machines” implemented in a virtualization environment that emulates the underlying hardware resources (e.g., CPU, memory, etc.). For example, multiple VMs can operate on one physical machine (e.g., host computer) running a single host operating system, while the VMs might run multiple applications on various respective guest operating systems. Another form of virtualization in distributed systems is operating system virtualization or container virtualization. The containers implemented in container virtualization environments comprise groups of processes and/or resources (e.g., memory, CPU, disk, etc.) that are isolated from the host computer and other containers. Such containers directly interface with the kernel of the host operating system without, in most cases, any hypervisor layer. As an example, certain applications can be implemented as containerized applications (CAs). Any of the foregoing virtualized entities can be implemented in distributed virtualization systems to facilitate execution of one or more workloads. For example, a VM might be created to operate as a SQL server, while another VM might be created to support a virtual desktop infrastructure (VDI).

The deployment of such virtualized entities in distributed virtualization systems to improve the effective utilization of system resources continues to scale to larger and larger installations. For example, some clusters in a distributed virtualization system might deploy hundreds of nodes or more that support several thousand or more autonomous virtualized entities (e.g., VMs, containers, etc.) that are individually tasked to perform one or more of a broad range of computing workloads. In many cases, several thousand virtual entities (VEs) might be launched (e.g., in a swarm) to perform some set of tasks, then finish and collate their results, then self-terminate. As such, the topology and/or resource usage activity of the distributed system can be highly dynamic. Users (e.g., administrators) of such large scale, highly dynamic distributed systems desire capabilities (e.g., computer-aided management tools) that facilitate analyzing and/or managing the distributed system resources so as to satisfy not only the then-current demands for resources, but also the foreseeable forthcoming demands for resources. For example, the administrators might desire capabilities that facilitate computer-aided cluster management (e.g., deployment, maintenance, scaling, etc.), computer-aided virtualized entity management (e.g., creation, placement, sizing, protection, migration, etc.), computer-aided storage management (e.g., allocation, policy compliance, location, etc.), and/or computer-aided management of any other aspects pertaining to computer-aided management of the resources of the distributed system.

### Workload-Based Resource Allocation Overview

Disclosed herein are techniques for implementing a workload detection and classification model to dynamically classify workloads to facilitate workload-based resource allocation in a distributed virtualization system. In certain embodiments, a workload detection and classification model is generated based on observed I/O activity trace data associated with certain workloads running on virtualized entities. The workload detection and classification model is trained by the foregoing information to facilitate dynamic classification of workloads running on virtualized entities in the distributed virtualization system based at least in part on the then-current I/O activity trace data. Workload parameters corresponding to the classified workloads are used to determine one or more resource allocation operations to facilitate dynamic resource allocation or distribution in the distributed virtualization system. Strictly as one example, the workload parameters can be combined with a set of predicted resource usage characteristics derived from a predictive model trained by historical resource usage measurements to determine the resource allocation operations. In other embodiments, certain other data, such as configuration data or policy rules, can be used to determine the workload parameters. In one or more embodiments, the resource allocation operations can be automatically executed by the system. In yet other embodiments, the resource allocation operations can be presented to a user as a set of recommended resource allocation operations to facilitate accepting or declining any of the operations. The recommended resource allocation operations and/or other information presented for analysis can be expressed in terms pertaining to named workloads.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

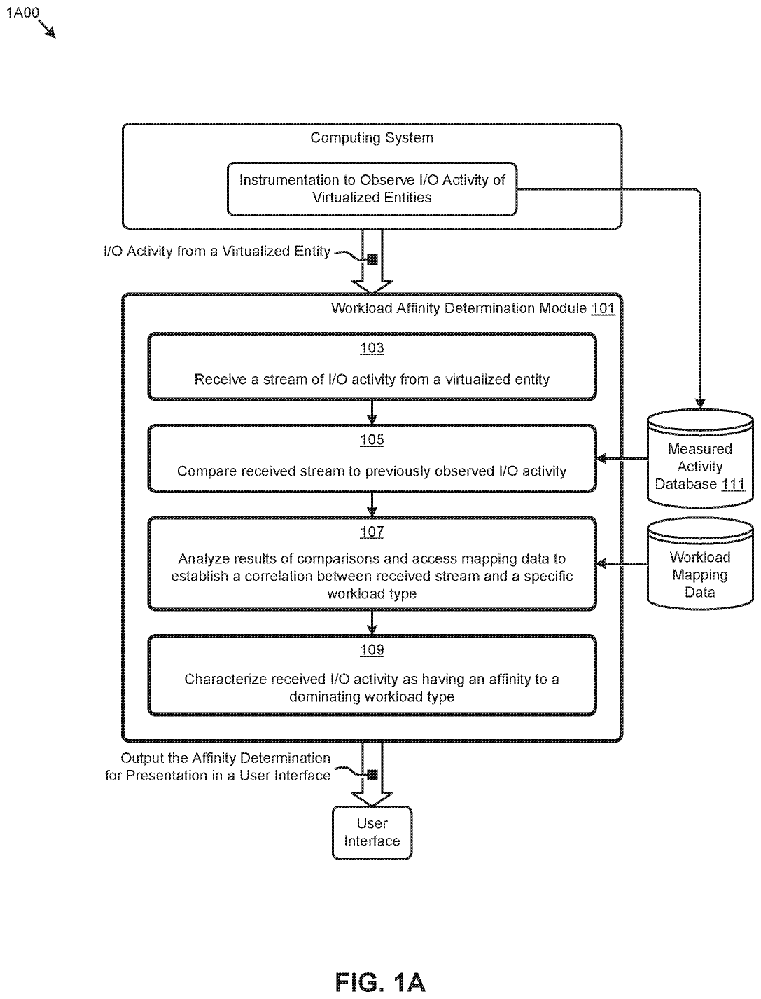

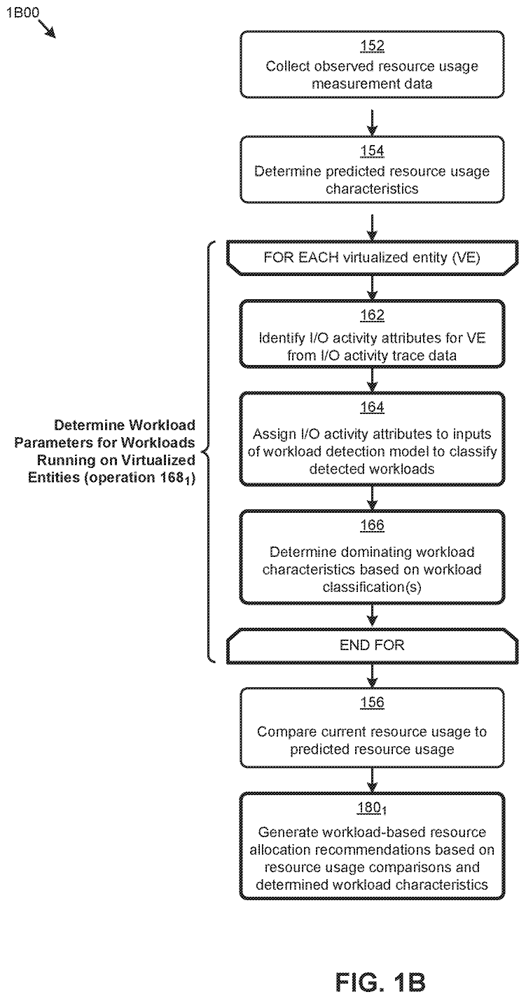

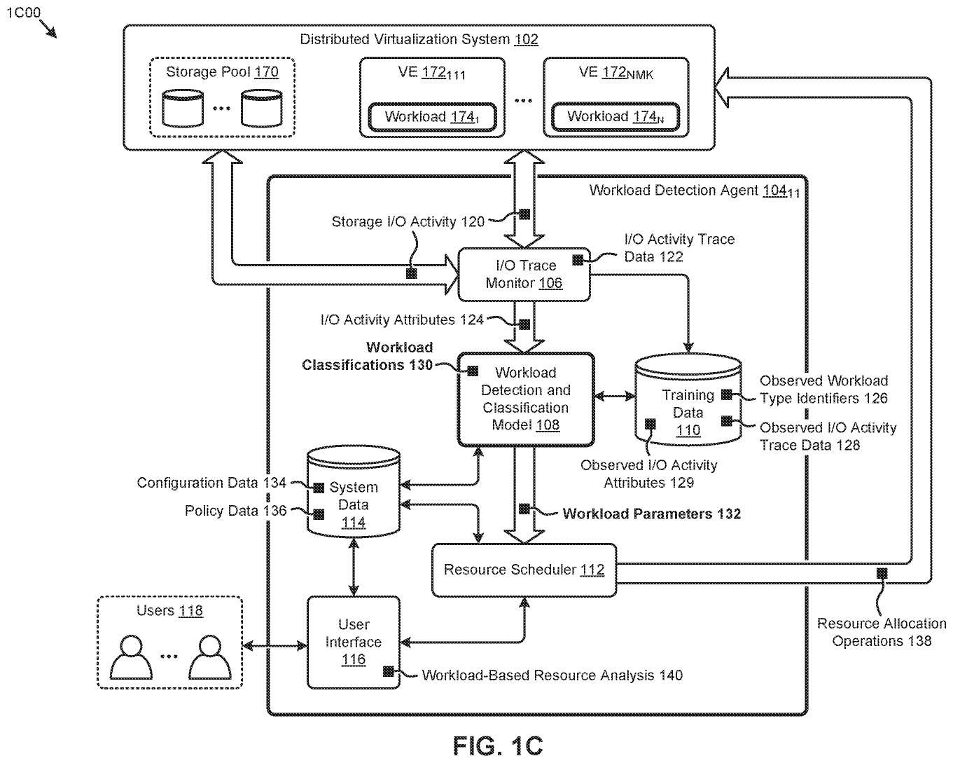

FIG. 1A presents a workload affinity determination technique 1A00. As an option, one or more variations of workload affinity determination technique 1A00 or any aspect thereof may be implemented in the context of the architecture and functionality of the embodiments described herein. The workload affinity determination technique 1A00 or any aspect thereof may be implemented in any environment.

The workload affinity determination technique 1A00 presents certain operations for implementing a computer-aided scheduling capability to allocate resources in a computing system based on observed resource usage. Specifically, workload affinity determination technique 1A00 can commence upon deploying instrumentation that serves to collect a set of observed I/O activity from virtualized entities. The observed resource usage measurement data are data records collected, for example, by a system monitor in the distributed virtualization system. The I/O activity and any other metrics that describe a level of usage pertaining to certain resource usage metrics (e.g., CPU usage, memory usage, storage usage, etc.) are stored to a measured activity database 111. The observed resource usage measurement data are often organized and/or stored in key-value pairs, where the key is the resource usage metric and the value is the level of usage for that metric. For example, a measurement for CPU usage might have a key of cpu and a value of 10 GHz.

A given stream of observations can be mapped to a particular type of workload using an affinity determination facility such as the shown workload affinity determination module 101. A stream of activity is received from a particular virtualized entity (at step 103). The activity stream or portion thereof is compared (at step 105) to previously-observed activity streams and/or any forms of resource usage measurement data as may be stored in the measured activity database 111. The comparison calculations may produce sufficient metrics such that the existence and characteristics of correlations between an activity stream and a previously observed activity stream can be determined. In some cases, and as shown by step 107, one or more correlations can be made between an activity stream and a particular workload type.

Given the correlation metrics, at step 109, an affinity between an activity stream and a particular workload type can be determined and quantified, which affinity in turn can be used in making resource allocation decisions. In some cases, and as shown, an affinity determination is provided to a user interface, which user interface can be viewed and manipulated by a user.

Various techniques can be used to determine the correlation metrics and/or affinities to a particular workload type. One technique, for example, can implement a predictive model that is trained by the observed resource usage measurement data.

Such techniques can be augmented by accounting for the effects of the varying workloads that consume the resources. Consideration of such effects can be combined with the determined affinities so as to influence the efficacy of resource allocations. One resource allocation might migrate one or more virtual machines (VMs) from a first node to a second node based solely on the then-current observed CPU resource usage. However, such a resource allocation operation might violate established business criticality specifications or rules (e.g., provided in a service level agreement) that pertain to other aspects of the workload running on the VMs. For example, migrating the VMs from a first node to a second node might violate a rule that states certain workloads are to run only on certain nodes (e.g., the first node). The herein disclosed techniques address workload-based constraints when dynamically allocating resources in a distributed virtualization system. One workload-based resource allocation technique that considers resource usage and constraints across multiple dimensions is shown and discussed as pertaining to FIG. 1B.

FIG. 1B presents a workload-based resource allocation technique 1B00 using dynamically classified workloads. As an option, one or more variations of workload-based resource allocation technique 1B00 or any aspect thereof may be implemented in the context of the architecture and functionality of the embodiments described herein. The workload-based resource allocation technique 1B00 or any aspect thereof may be implemented in any environment.

The workload-based resource allocation technique 1B00 presents one embodiment of certain operations for facilitating performing distributed resource allocation using dynamically classified workloads according to the herein disclosed techniques. Specifically, workload-based resource allocation technique 1B00 can commence with collecting a set of observed (e.g., historical) resource usage measurement data (operation 152). A set of predicted resource usage characteristics can be determined based at least in part on the observed resource usage measurement data (operation 154). To implement the herein disclosed techniques, a set of operations can be used to determine various workload parameters for any workload or workloads running on the virtualized entities (VEs) in a given distributed virtualization system (see operation 168₁). Specifically, for each VE, I/O activity trace data for the respective VE is retrieved (at operation 162) from I/O activity attributes (e.g., as stored in a measured activity database 111).

As used herein, I/O activity trace data is a set of information describing storage access activity (e.g., reads, writes, etc.) for a given entity or entities. The I/O activity trace data can comprise a set of data records holding information describing certain information pertaining to each access or a collection of accesses. For example, I/O activity trace data might comprise a set of log entries with each entry describing a VE identifier, a node identifier, a storage target (e.g., vDisk, extent, etc.) identifier, a block size, a timestamp, and/or other parameters. I/O activity attributes are a set of attributes that characterize a set of I/O activity trace data. Such characteristics might include a measure of the number of random accesses as compared to the number of sequential accesses, a measure of the number of write accesses as compared to the number of read accesses, an average block size per access, a maximum block size, a minimum block size, and/or other characteristics. The I/O activity attributes are often organized and/or stored in key-value pairs, where the key is the attribute and the value is a quantifiable value for that attribute. For example, an attribute pertaining to the number of random accesses might have a key of random and a value of 80%.

Referring again to operation 168₁ in FIG. 1B, the I/O activity attributes for each VE can be applied to the inputs of a workload detection and classification model to classify the workload or workloads running on the VE (operation 164). The workload detection and classification model is a collection of mathematical techniques (e.g., algorithms) that facilitate determining (e.g., predicting) a set of outputs (e.g., outcomes, responses) based on a set of inputs (e.g., stimuli). For example, the workload detection and classification model might consume a set of I/O activity attributes as inputs to determine a workload classification corresponding to the set of I/O activity attributes. In some cases, the techniques implemented by the model might comprise a set of equations having coefficients that relate one or more of the input variables to one or more of the output variables. In these cases, the equations and coefficients can be determined by a training process. In other cases, the model can map discrete combinations of inputs (e.g., I/O activity attributes) to respective combinations of outputs (e.g., workload classifications). Such workload classifications are a set of one or more identifiers sufficient for uniquely identifying a certain workload type and/or configuration. For example, a workload pertaining to a SQL server implementation might have a matching workload classification represented by a key-value pair comprising a key of type and a value of sql. In other cases, the workload classification for the SQL server can comprise other parameters describing certain aspects of the workload instance, such as the number of databases (e.g., 3), the size of the databases (e.g., Large), the type of the databases (e.g., CLAP), and/or other parameters.

The foregoing parameters pertaining to the workload classifications determined by the workload detection and classification model and/or other parameters can comprise a set of workload parameters determined by the herein disclosed techniques (operation 166). The dominant workload parameters are a set of parameters corresponding to each workload detected in the distributed virtualization system that are deemed (e.g., by a heuristic) or calculated (e.g., by comparing measured data or coefficients) to be of interest when making resource allocation decisions.

In addition to any of the aforementioned parameters related to the workload classification of the detected workload, the workload parameters can further comprise parameters describing the logical and/or physical location of the workload (e.g., VE identifier, node identifier, cluster identifier, site identifier, etc.), the user or users interacting with the workload (e.g., user identifiers, etc.), the owner of the workload (e.g., enterprise identifier, etc.), storage IO parameters (e.g., block size, read or write counts per virtual machine, counts of sequential IO, counts of random IO, ratio between counts of sequential IO and counts of random IO, duration of IO operations, maximum number of concurrently outstanding IO operations, etc.) and/or other parameters of interest. The workload parameters can be grouped and/or preprocessed to form hypothesis or other inputs used in heuristics to determine a workload type. For example, given a ratio of 80% of IO being reads and 20% of IOs being writes, and given an outstanding IO count of 5 and given a block size of 4 k bytes, the corresponding workload might be deemed to be a virtual desktop workload. Any such workload parameters and/or any such groupings and/or any such hypotheses are often organized and/or stored in key-value pairs, where the key is the parameter or grouping or hypothesis and the value is the value for that key.

For example, a set of workload parameters might comprise key-value pairs of WLid=WL4, WLtype=vdi and entity=vm32. In some cases, certain workload parameters can be taken from or derived from system data. For example, a set of configuration data might indicate that entity vm32 is associated with node N248 so as to include the key-value pair node=N248 in the workload parameters corresponding to workload WL4. As another example, a set of policy data might indicate that vm32 running workload WL4 is under an affinity restriction so as to include the key-value pair affinity=yes in the workload parameters corresponding to workload WL4. As yet another example, the policy data might further indicate node N248 is designated to run all VDI workloads in the cluster. In this case, a key-value pair restricted=N248 might be included in the workload parameters corresponding to workload WL4.

As can be observed in the workload-based resource allocation technique 1B00, the workload parameters determined by the herein disclosed techniques can facilitate workload-based resource allocation by augmenting the comparison of current resource usage to predicted resource usage characteristics (operation 156) to determine resource allocation operations based on the resource usage comparison and the workload parameters (operation 180₁). The workload parameters serve to account for workload-based constraints when dynamically allocating resources in a distributed virtualization system. Strictly as one example, resource allocation operations pertaining to migrating VMs might be constrained by one or more of the workload parameters corresponding to the workloads detected as running on the VMs according to the herein disclosed techniques. One implementation of various system components and/or interactions for facilitating the foregoing workload-based resource allocation technique and/or other herein disclosed techniques is shown and described as pertaining to FIG. 1C.

Referring again to resource usages, current resource usage can be described by resource usage measurement data collected at some moment in time contemporaneous with some specified analysis period. For example, current resource usage might correspond to individual measurements taken within the last hour, as compared to earlier observed resource usage measurement data which might correspond to individual measurements taken over a much longer time period, such as a month or a year. In many cases, the resource allocation operations are invoked in response to one or more of the current resource usage measurements breaching some threshold derived from the predicted resource usage characteristics. For example, if the predicted CPU usage is 100 GHz, a threshold at 85% of 100 GHz might be established so as to trigger a resource allocation operation (e.g., user alert, remediation action, etc.) when the then-current CPU usage breaches that threshold. Current resource usage can be used in conjunction with workload classification techniques when performing distributed resource allocation.

FIG. 1C depicts a set of techniques 1C00 used when performing distributed resource allocation using dynamically classified workloads. As an option, one or more variations of techniques 1C00 or any aspect thereof may be implemented in the context of the architecture and functionality of the embodiments described herein. The techniques 1C00 or any aspect thereof may be implemented in any environment.

The embodiment shown in FIG. 1C comprises a workload detection agent 104₁₁ that facilitates workload modeling to perform distributed resource allocation for a distributed virtualization system 102 using dynamically classified workloads according to the herein disclosed techniques. Specifically, and as shown, workload detection agent 104₁₁ comprises an I/O trace monitor 106 to monitor (e.g., “trace”) a set of storage I/O activity 120 associated with various workloads (e.g., workload 174₁, . . . , workload 174_{N}) operating at certain virtualized entities (e.g., VE 172₁₁₁, . . . , VE 172_{NMK}, respectively) at distributed virtualization system 102. As an example, storage I/O activity 120 can be between the virtualized entities and a storage pool 170 in the distributed virtualization system 102. A set of I/O activity trace data 122 corresponding to the storage I/O activity 120 is collected by I/O trace monitor 106. The I/O trace monitor 106 can further identify various sets of I/O activity attributes 124 associated with the I/O activity trace data 122. For example, each set of I/O activity attributes 124 might correspond to a respective virtualized entity and/or a respective workload.

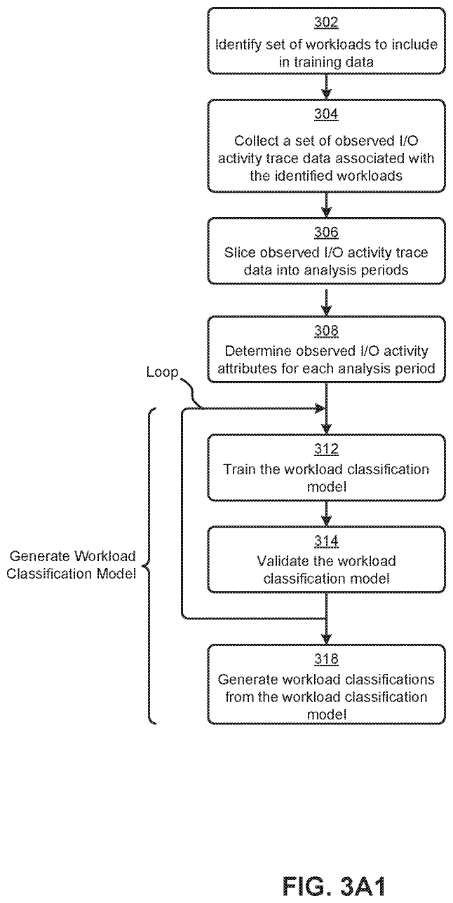

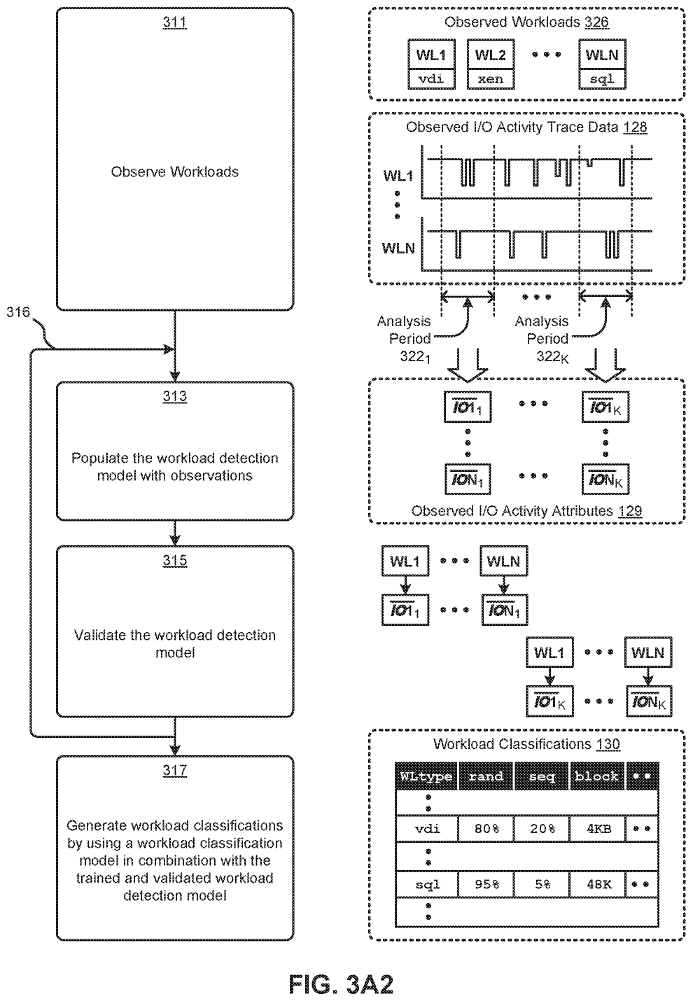

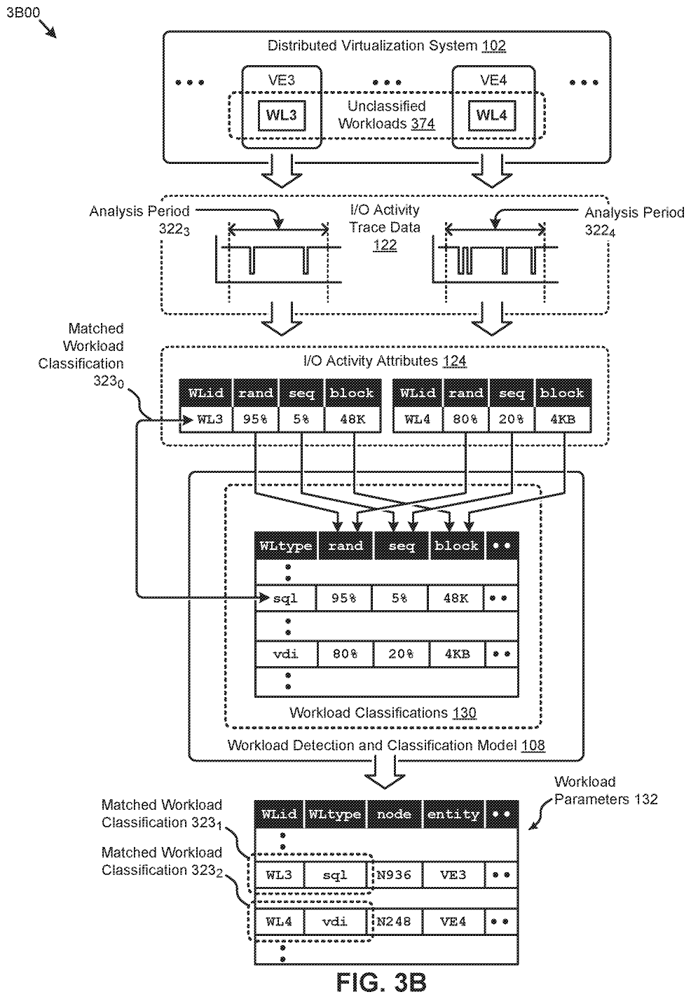

As can be observed, various observed (e.g., historical) portions of I/O activity trace data 122 and associated I/O activity attributes 124 can be stored in a set of training data 110 for training a workload detection and classification model 108. Specifically, a set of observed I/O activity trace data 128 and a set of observed I/O activity attributes 129 are shown as stored in training data 110. Also, a set of observed workload type identifiers 126 associated with observed I/O activity trace data 128 and observed I/O activity attributes 129 can be stored in training data 110 to facilitate training of the workload detection and classification model 108. The observed workload type identifiers 126 are collections of one or more units of information that describe the type of a given observed workload associated with a set of observed I/O activity trace data and/or observed I/O activity attributes. For example, an observed workload type identifier for an observed VDI workload might be described by a key-value pair having a key of type and a value of vdi. In some cases, an “observed” workload might be distinguished from other (e.g., unknown) workloads by the availability of a set of workload type identifying information for the observed workload. The generated workload detection and classification model 108 comprises relationships (e.g., correlations, weighted correlations, coefficients, dominance, etc.) between observed I/O activity (e.g., activity trace data) and workload type identifiers. Specific examples of such relationships are shown and discussed in FIG. 3A1, FIG. 3A2, and FIG. 3B.

In some cases, training data 110 can be used by workload detection and classification model 108 to determine a set of workload classifications 130 that can be assigned to various sets of I/O activity attributes 124. Further details related to training the workload detection and classification model 108 using the foregoing training data and/or other data is shown and described as pertaining to the following figures.

As shown in FIG. 1C, the I/O activity attributes 124 delivered by I/O trace monitor 106 are exposed to (e.g., assigned to the inputs of) the workload detection and classification model 108 to classify the workloads in the distributed virtualization system 102. Specifically, the workloads are classified by assigning one of the workload classifications 130 from workload detection and classification model 108 to a respective set of I/O activity attributes. The workload detection and classification model 108 can then determine a set of one or more workload parameters 132 based at least in part on the workload classifications assigned to the I/O activity attributes. The resulting workload parameters characterize the workloads in the distributed virtualization system 102 so as to facilitate workload-based resource allocation in the system.

Specifically, a set of workload parameters 132 can be consumed by a resource scheduler 112 to generate one or more resource allocation operations 138 for execution at the distributed virtualization system 102. In some cases the resource allocation operations 138 can be further be based on various instances of system data 114, such as configuration data 134 and/or policy data 136. Workload detection agent 104₁₁ can further comprise a user interface 116 to facilitate a workload-based resource analysis 140 by one or more users 118 (e.g., system administrators). For example, certain recommended instances of the resource allocation operations 138 and/or other information (e.g., resource usage metrics) can be presented in user interface 116 for analysis, expressed in terms pertaining to the classified workloads in the system.

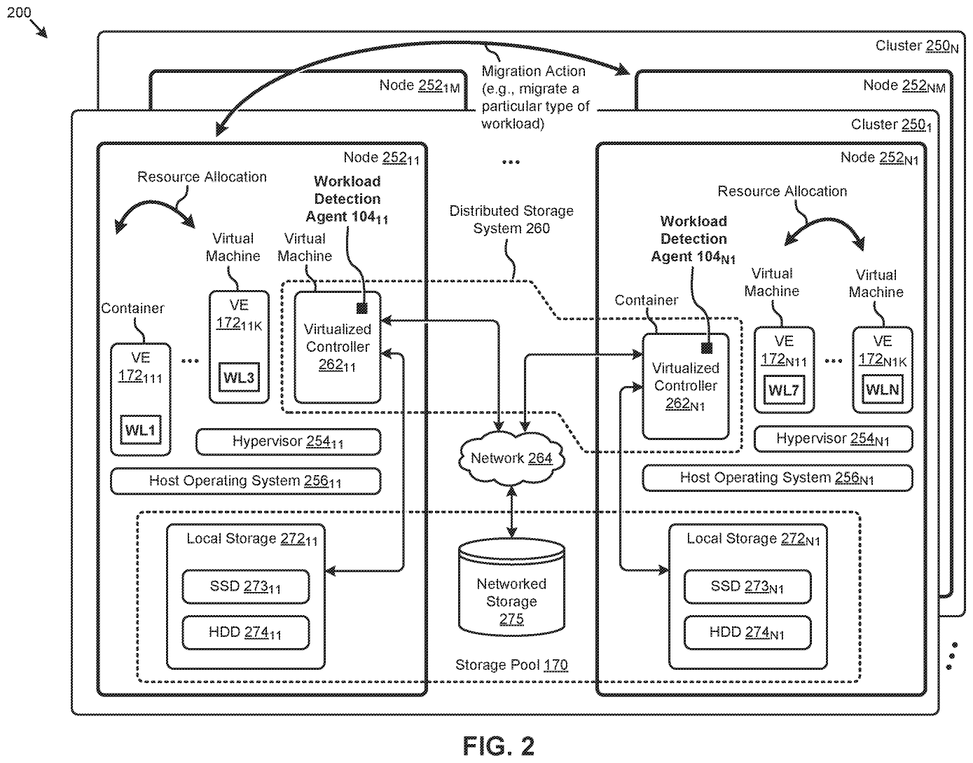

The components, data flows, and data structures shown in FIG. 1C presents merely one partitioning and associated data manipulation approach. The specific example shown is purely exemplary, and other subsystems and/or partitionings are reasonable. One embodiment of an environment depicting such systems, subsystems, and/or partitionings is shown and described as pertaining to FIG. 2.

FIG. 2 depicts a distributed virtualization environment 200 in which embodiments of the present disclosure can operate. As an option, one or more variations of distributed virtualization environment 200 or any aspect thereof may be implemented in the context of the architecture and functionality of the embodiments described herein. The distributed virtualization environment 200 or any aspect thereof may be implemented in any environment.

The distributed virtualization environment 200 shows various components associated with one instance of a distributed virtualization system (e.g., hyperconverged distributed system) comprising a distributed storage system 260 that can be used to implement the herein disclosed techniques. Specifically, a workload detection agent can predict that a workload running in a particular node of a first cluster might perform better and/or achieve improved resource utilization if that workload were situated in, for example, a different cluster. Upon such a prediction, resource reallocation operations and/or migration operations can be invoked so as to pursue the predicted improvements.

Many forms of inter- and intra-cluster resource reallocation operations and/or migration operations are possible in distributed virtualization environments. As shown, the distributed virtualization environment 200 comprises multiple clusters (e.g., cluster 250₁, . . . , cluster 250_{N}) comprising multiple nodes (e.g., node 252₁₁, . . . , node 252_{1M}, node 252_{N1}, . . . , node 252_{NM}) that have multiple tiers of storage in storage pool 170. For example, each node can be associated with one server, multiple servers, or portions of a server. The nodes can be associated (e.g., logically and/or physically) with the clusters. As shown, the multiple tiers of storage include storage that is accessible through a network 264, such as a networked storage 275 (e.g., storage area network or SAN, network attached storage or NAS, etc.). The multiple tiers of storage further include instances of local storage (e.g., local storage 272₁₁, . . . , local storage 272_{N1}). For example, the local storage can be within or directly attached to a server and/or appliance associated with the nodes. Such local storage can include solid state drives (SSD 273₁₁, . . . , SSD 273_{N1}), hard disk drives (HDD 274₁₁, . . . , HDD 274_{N1}), and/or other storage devices.

As shown, the nodes in distributed virtualization environment 200 can implement one or more user virtualized entities (e.g., VE 172₁₁₁, . . . , VE 172_{11K}, . . . , VE 172_{N11}, . . . , VE 172_{N1K}, such as virtual machines (VMs) and/or containers. The VMs can be characterized as software-based computing “machines” implemented in a full virtualization environment that emulates the underlying hardware resources (e.g., CPU, memory, etc.) of the nodes. For example, multiple VMs can operate on one physical machine (e.g., node host computer) running a single host operating system (e.g., host operating system 256₁₁, . . . , host operating system 256_{N1}), while the VMs run multiple applications on various respective guest operating systems. Such flexibility can be facilitated at least in part by a hypervisor (e.g., hypervisor 254₁₁, . . . , hypervisor 254_{N1}), which hypervisor is logically located between the various guest operating systems of the VMs and the host operating system of the physical infrastructure (e.g., node).

As an example, hypervisors can be implemented using virtualization software (e.g., VMware ESXi, Microsoft Hyper-V, RedHat KVM, Nutanix AHV, etc.) that includes a hypervisor. In comparison, the containers (e.g., application containers or ACs) are implemented at the nodes in an operating system virtualization or container virtualization environment. The containers comprise groups of processes and/or resources (e.g., memory, CPU, disk, etc.) that are isolated from the node host computer and other containers. Such containers directly interface with the kernel of the host operating system (e.g., host operating system 256₁₁, . . . , host operating system 256_{N1}) with, in most cases, no hypervisor layer. This lightweight implementation can facilitate efficient distribution of certain software components such as applications or services (e.g., micro-services). As shown, distributed virtualization environment 200 can implement both a full virtualization environment and a container virtualization environment for various purposes.

Distributed virtualization environment 200 also comprises at least one instance of a virtualized controller to facilitate access to storage pool 170 by the VMs and/or containers. Multiple instances of such virtualized controllers can coordinate within a cluster to form the distributed storage system 260 which can, among other operations, manage the storage pool 170. This architecture further facilitates efficient scaling of the distributed virtualization system. The foregoing virtualized controllers can be implemented in distributed virtualization environment 200 using various techniques.

Specifically, an instance of a virtual machine at a given node can be used as a virtualized controller in a full virtualization environment to manage storage and I/O activities. In this case, for example, the virtualize entities at node 252₁₁ can interface with a controller virtual machine (e.g., virtualized controller 262₁₁) through hypervisor 254₁₁ to access the storage pool 170. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 260. For example, a hypervisor at one node in the distributed storage system 260 might correspond to VMware ESXi software, and a hypervisor at another node in the distributed storage system 260 might correspond to Nutanix AHV software. As another virtualized controller implementation example, containers (e.g., Docker containers) can be used to implement a virtualized controller (e.g., virtualized controller 262_{N1}) in an operating system virtualization environment at a given node. In this case, for example, the virtualized entities at node 252_{N1} can access the storage pool 170 by interfacing with a controller container (e.g., virtualized controller 262_{N1}) through hypervisor 254_{N1} and/or the kernel of host operating system 256_{N1}.

In certain embodiments, one or more instances of a workload detection agent can be implemented in the distributed storage system 260 to facilitate the herein disclosed techniques. Specifically, workload detection agent 104₁₁ can be implemented in the virtualized controller 262₁₁, and workload detection agent 104_{N1} can be implemented in the virtualized controller 262_{N1}. Such instances of the workload detection agent can be implemented in any node in any cluster. In certain embodiments, the workload detection agents can perform various operations pertaining to the workloads (e.g., WL1, . . . , WL3, . . . , WL7, . . . , WLN) executed in distributed virtualization environment 200 according to the herein disclosed techniques.

As an example, the workload detection agents can implement models to dynamically classify workloads that use the virtualized controllers to access the storage pool 170. Workload parameters describing the classified workloads can be used to facilitate workload-based resource allocation in distributed virtualization environment 200. Specifically, the workload detection agents might facilitate generation of certain resource allocation operations to deploy to the distributed system. As can be observed, the resource allocations associated with such resource allocation operations can occur within a node, between nodes, between clusters, and/or between any resource subsystems accessible by the workload detection agents.

As earlier described, such workload-based dynamic resource allocations facilitated by the workload detection agent according to the herein disclosed techniques can be facilitated at least in part by one or more workload detection models and/or one or more workload classification models. Further details related to such workload-related models are shown and described as pertaining to FIG. 3A1 and FIG. 3A2.

FIG. 3A1 presents a workload classification model generation technique as implemented in systems for distributed resource allocation using dynamically classified workloads. As an option, one or more variations of workload classification model generation technique of FIG. 3A1 or any aspect thereof may be implemented in the context of the architecture and functionality of the embodiments described herein. The workload classification model generation technique or any aspect thereof may be implemented in any environment.

The workload classification model generation technique presents one embodiment of certain operations for generating a workload classification model for dynamically classifying workloads so as to facilitate distributed resource allocation according to the herein disclosed techniques. In certain embodiments, the shown operations can be executed by an instance of a workload detection agent (e.g., such as earlier shown and described as pertaining to FIG. 1C).

A workload classification model generation technique can commence by identifying a set of workloads to include in a set of training data (operation 302). The identified workloads can comprise a set of workloads in a given distributed virtualization system that is representative of all the workloads that might run in the system. As an example, the identified workloads might comprise at least one workload of a given workload type such as a VDI workload, a XenApp workload, or a SQL server workload. Such representative workloads can be referred to as “observed workloads” to indicate that certain characteristics of the workloads are being observed to facilitate formation of the training data for the workload classification model. For example, as shown in FIG. 3A2, a set of observed workloads 326 might include certain representative workloads (e.g., WL1, WL2, . . . , WLN) identified by respective instances of observed workload type identifiers 126 (e.g., vdi, xen, sql, respectively).

A set of observed I/O activity trace data associated with the earlier identified workloads (e.g., observed workloads 326) can be collected (operation 304). In the example shown, observed I/O activity trace data 128 (see FIG. 3A2) can be selected for observed workloads. The number of samples and/or period of time pertaining to the collected data can vary. Specifically, the data set collected might be sized to facilitate slicing the observed I/O activity trace in multiple analysis periods, with each analysis period comprising a statistically significant number of samples (operation 306). A statistically significant number of samples can refer to a number of samples that permits training and validation of the workload classification model so as to provide a confidence or probability level associated with the results generated by the model for its intended purpose (e.g., classifying workloads). The observed I/O activity trace data for each analysis period can be examined to determine a corresponding set of observed I/O activity attributes (operation 308).

Such data can be used to generate a workload classification model. Specifically, a workload classification model can be trained (at step 312), which model can be validated (at step 314), and then used to generate workload classifications (at step 318). The generated workload classifications can be used in turn to make resource allocation decisions that are based on a priori known workload resource demands.

Classification of a particular stream (e.g., using a workload classification model) can be used in conjunction with a priori known workload streams, however not all streams are known a priori. As such a workload classification model can be enhanced with additional temporal information in the form of a workload detection model. Moreover, the aforementioned workload detection and classification model 108 (see FIG. 1A) can be formed of all or portions of a workload classification model and/or all or portions of a workload detection model. A workload detection model generation technique is presently discussed.

FIG. 3A2 presents model generation technique for forming a workload detection model. Not all observed I/O activity is necessarily I/O activity from a workload. Some I/O activity might result from system I/O that is not associated with any classified workload. Moreover, certain I/O activity in certain time periods might be more correlated to a respective workload than I/O activity in other time periods. Accordingly, only certain data from certain analysis periods are selected from trace data to be used in forming a workload detection model.

As shown, I/O activity of workloads are observed at step 311. The observed I/O activity attributes can be represented as vectors (e.g., I̅O̅1̅₁, . . . , I̅O̅N̅₁, I̅O̅1̅_{K}, . . . , I̅O̅N̅_{K}) comprising a set of I/O activity attribute values taken over a time period. For example, vector I̅O̅N̅_{K} can comprise an attribute set such as {RN_{K}, SN_{K}, BN_{K}, etc.} for workload WLN derived from the time period shown as analysis period 322_{K}. In this example, attribute RN_{K} refers to the percentage of random accesses as compared to the total number of accesses, attribute SN_{K} refers to the percentage of sequential accesses as compared to the total number of accesses, and attribute BN_{K} refers to the average block size per access. A portion of the observed I/O activity (e.g., I̅O̅1̅₁, . . . , I̅O̅N̅₁ from analysis period 322₁) and/or any of its constituent attributes can be used to populate the workload detection model (operation 313). A different portion of the observed I/O (e.g., I̅O̅1̅_{K}, . . . , I̅O̅N̅_{K} from analysis period 322_{K}) can be used to validate the workload detection model (operation 315).

The processes of training and/or validating can be iterated (over path 316) until the workload detection model behaves within target tolerances (e.g., with respect to predictive statistic metrics, descriptive statistics, significance tests, etc.). In some cases, additional data (e.g., taken from observed I/O activity trace data 128) can be collected to further train and/or validate the workload detection model.

The process of generating the workload classifications can include use of the workload detection model in combination with a workload classification model (operation 317). As shown in the example instance of workload classifications 130, workload classifications can be organized in a tabular structure (e.g., relational database table) having rows associated with a respective workload classification and columns associated with certain attributes for each workload classification. In some embodiments, the attributes can characterize a workload type or workload classification (e.g., wLtype), a random access percentage (e.g., rand), a sequential access percentage (e.g., seq), an average access block size (e.g., block), and/or other attributes. For example, a vdi workload classification might have a random access percentage of 80%, a sequential access percentage of 20%, and an average access block size of 4 KB.

A workload detection model, used in conjunction with a workload classification model can be used to classify workloads to facilitate dynamic resource allocation in a distributed virtualization system. Further workload classification techniques are shown and described as pertaining to FIG. 3B.

FIG. 3B presents a workload classification technique 3B00 as implemented in systems for distributed resource allocation using dynamically classified workloads. As an option, one or more variations of workload classification technique 3B00 or any aspect thereof may be implemented in the context of the architecture and functionality of the embodiments described herein. The workload classification technique 3B00 or any aspect thereof may be implemented in any environment.

The workload classification technique 3B00 shown in FIG. 3B depicts one example of data structures and data transformations used to assign workload classifications and determine workload parameters for various workloads in a distributed virtualization system. Specifically, workload classification technique 3B00 can assign instances of workload classifications 130 and determine sets of workload parameters 132 for workloads (e.g., WL3 and WL4) operating at various virtualized entities (e.g., VE3 and VE4) in distributed virtualization system 102. In many cases, workload classification technique 3B00 can be implemented to classify one or more unclassified workloads, such as unclassified workloads 374, running in the system. In such cases, merely an awareness that some workload is operating at a given VE is known, and classifying the workload can facilitate workload-based resource allocation at the distributed virtualization system.

To classify the workloads according the techniques disclosed herein, the I/O activity trace data 122 for each VE be monitored to identify certain instances of I/O activity attributes 124 pertaining to the VE. Specifically, and as shown, a portion of the I/O activity trace data for the VE comprising an analysis period (e.g., analysis period 3223 and analysis period 3224) can be analyzed to determine a respective set of I/O activity attributes. As earlier described, the I/O activity attributes might be represented as a vector. As shown in FIG. 3B, the I/O activity attributes for a give VE can also be represented as a row in a database table. For example, a table row corresponding to unclassified workload WL3 might have a WLid column with a value of WL3, a rand (e.g., for percentage of random accesses) column with a value of 95%, a seq (e.g., for percentage of sequential accesses) with a value of 5%, and a block (e.g., for average block size) column with a value of 48 KB. A representative example row for unclassified workload WL4 is also shown.

The I/O activity attributes (e.g., rand, seq, and block) for each VE can be applied to the inputs of a workload detection and classification model 108 to classify the workloads running at distributed virtualization system 102. Specifically, as shown, the attributes for unclassified workloads WL3 and WL4 in I/O activity attributes 124 are applied to the corresponding attribute in workload classifications 130 at the workload detection and classification model 108. In some embodiments, the workload classification is determined by matching the I/O activity attributes to the workload classification attributes (e.g., determining a best match) to identify one or more a matched workload classifications (e.g., matched workload classification 323₀, matched workload classification 323₁, matched workload classification 323₂). For example, the I/O activity attributes pertaining to WL3 match the attributes of the SQL workload classification (shown as matched workload classification 323₁) and the I/O activity attributes pertaining to WL4 match the attributes of the VDI workload classification (shown as matched workload classification 323₂).

A set of workload parameters 132 comprising the identified classifications for each workload analyzed from the distributed virtualization system 102 are generated, stored, and made available to downstream processes. In some cases, the workload parameters for a given workload can include other information. Specifically, as illustrated, workload WL3, now classified, can be associated with a wLtype parameter of sql, a node parameter of N936, an entity parameter of VE3, and/or other workload parameters.

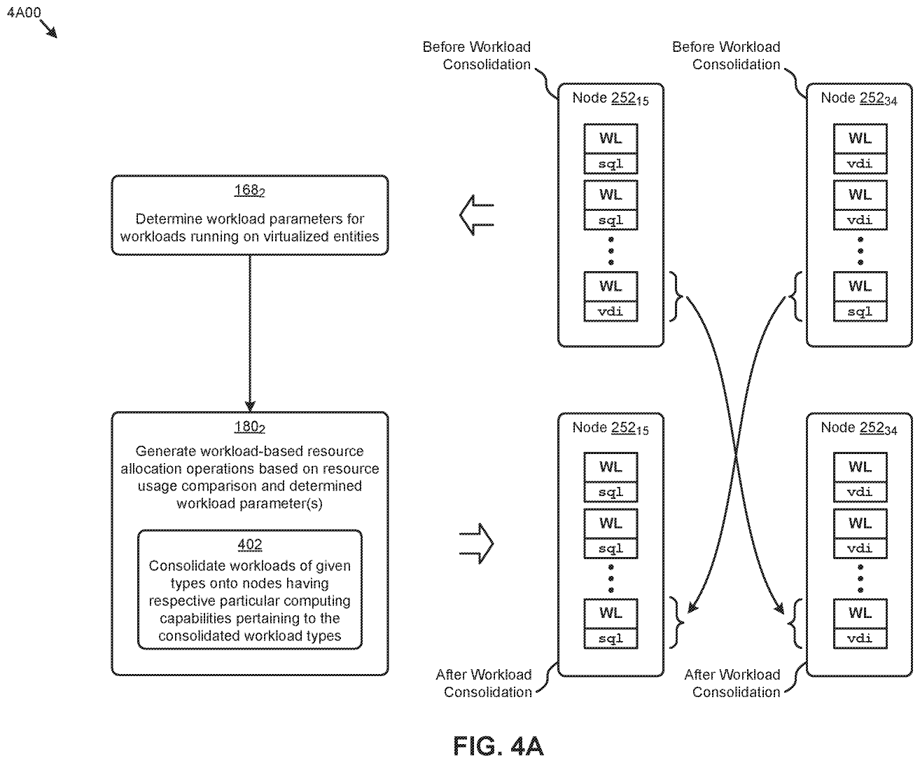

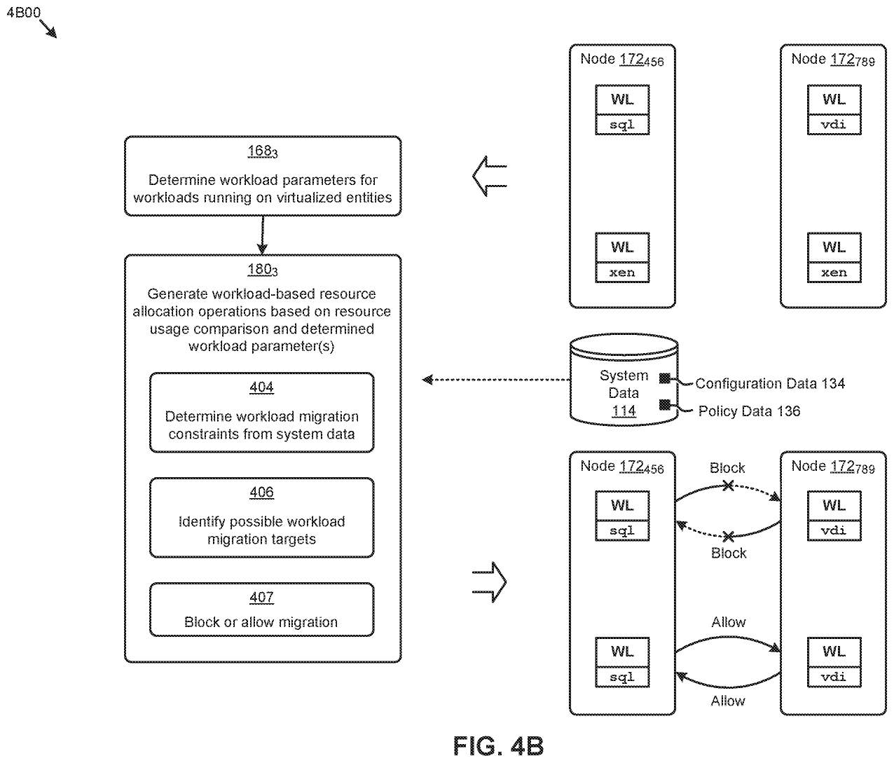

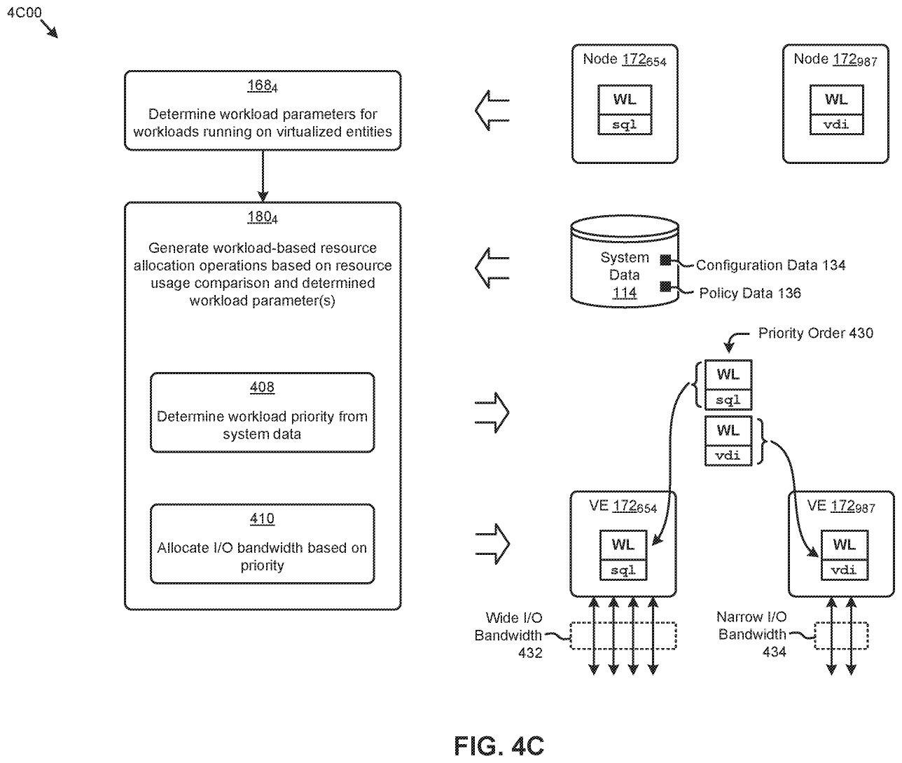

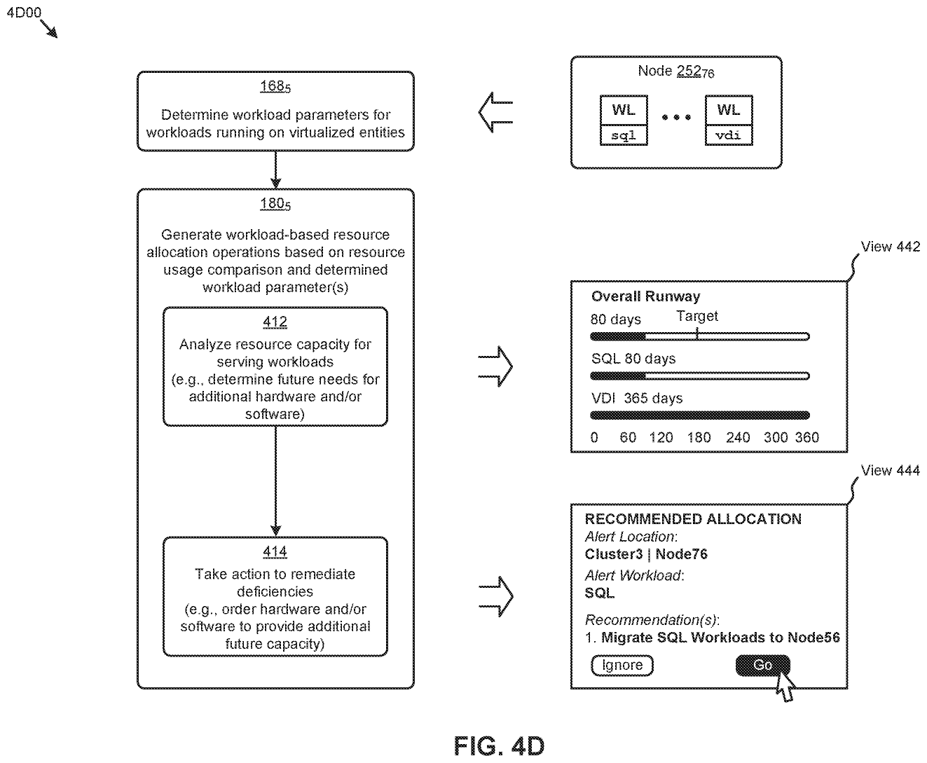

Such workload parameters determined by the herein disclosed techniques can facilitate various workload-based resource allocation and/or analysis operations, such as the examples shown and described as pertaining to FIG. 4A, FIG. 4B, FIG. 4C, and FIG. 4D.

FIG. 4A presents a workload consolidation technique 4A00 as implemented in systems for distributed resource allocation using dynamically classified workloads. As an option, one or more variations of workload consolidation technique 4A00 or any aspect thereof may be implemented in the context of the architecture and functionality of the embodiments described herein. The workload consolidation technique 4A00 or any aspect thereof may be implemented in any environment.

As illustrated in FIG. 4A, the herein disclosed techniques can be implemented to determine workload parameters for workloads running on virtualized entities in a distributed virtualization system (operation 168₂). For example, and as shown, workload parameters can be determined for certain workloads on node 252₁₅ and node 252₃₄. The workload type from the workload parameters of the representative workloads (WLs) at each node are also shown. Specifically, at least two SQL server workloads and at least one VDI workload are detected as running at node 252₁₅, and at least two VDI workloads and at least one SQL server workload are detected as running at node 252₃₄.

Using the workload parameters for the aforementioned workloads determined by the herein disclosed techniques, various workload-based resource allocation operations can be generated (operation 180₂). As one example of workload-based resource allocation operations, the workload parameters can be used to consolidate workloads of a given type onto a node that is configured with resources that correspond to the demands of the consolidated workloads (operation 402). As can be observed in this example, the resource allocation operations result in node 252₁₅ being tasked with servicing consolidated SQL server workloads and node 252₃₄ being tasked with servicing consolidated VDI workloads.

FIG. 4B presents a workload firewalling technique 4B00 as implemented in systems for distributed resource allocation using dynamically classified workloads. As an option, one or more variations of workload firewalling technique 4B00 or any aspect thereof may be implemented in the context of the architecture and functionality of the embodiments described herein. The workload firewalling technique 4B00 or any aspect thereof may be implemented in any environment.

As presented in FIG. 4B, the herein disclosed techniques can be implemented to determine workload parameters for workloads running on virtualized entities in a distributed virtualization system (operation 1683). For example, and as shown, workload parameters can be determined for certain workloads running on VE 172₄₅₆ and VE 172₇₈₉. The workload type from the workload parameters of the representative workloads (WLs) at each virtualized entity are also shown. Specifically, a SQL server workload and a XenApp workload are detected as running on VE 172₄₅₆, and a VDI workload and a XenApp workload are detected as running on VE 172₇₈₉.

Using the workload parameters for the aforementioned workloads determined by the herein disclosed techniques, various workload-based resource allocation operations (e.g., workload migrations) can be generated (operation 180₃). As one example of workload-based resource allocation operations, the workload parameters can be used to determine workload migration constraints from the system data (operation 404). For example, configuration data 134 and/or policy data 136 from system data 114 might be used to determine the constraints, if any, for migrating the earlier described SQL server workload and/or VDI workload and/or XenApp workload to or from VE 172₄₅₆ and VE 172₇₈₉. The constraints can then be used to identify possible workload migration targets (operation 406), after which identification, migration can be blocked (e.g., disallowed) or can be initiated (operation 407). In the example illustrated in FIG. 4B, such constraints might block SQL server workloads from migrating to VE 172₇₈₉ and might block VDI workloads from migrating to VE 172₄₅₆, while permitting XenApp workloads to operate on either virtualized entity.

FIG. 4C presents a workload prioritization technique 4C00 as implemented in systems for distributed resource allocation using dynamically classified workloads. As an option, one or more variations of workload prioritization technique 4C00 or any aspect thereof may be implemented in the context of the architecture and functionality of the embodiments described herein. The workload prioritization technique 4C00 or any aspect thereof may be implemented in any environment.

As depicted in FIG. 4C, the herein disclosed techniques can be implemented to determine workload parameters for workloads running on virtualized entities in a distributed virtualization system (operation 1684). For example, and as shown, workload parameters can be determined for certain workloads running on VE 172₆₅₄ and VE 172₉₈₇. The workload types from the workload parameters pertaining to the representative workloads at the virtualized entities are also shown. Specifically, a SQL server workload is detected to be running on VE 172₆₅₄ and a VDI workload is detected to be running on VE 172₉₈₇.

Using the workload parameters for the aforementioned workloads determined by the herein disclosed techniques, various workload-based resource allocation operations can be generated (operation 180₄). As one example of workload-based resource allocation operations, the workload parameters can be used to determine a workload priority from the system data (operation 408). For example, configuration data 134 and/or policy data 136 from system data 114 might be used to determine a priority order 430 that indicates a SQL server workload has a priority level that is higher than the priority level of a VDI workload. Such priorities, for example, might be derived from business criticality rules comprising the policy data 136. The priority order 430 can then be used to implement bandwidth control (e.g., to allocate I/O bandwidth) pertaining to the various workloads (operation 410) and/or bandwidth control pertaining to selection of nodes that serve as target nodes for migration based on sufficient bandwidth availability. As shown, the higher priority SQL server workload from VE 172₆₅₄ can be allocated a wide I/O bandwidth 432 as compared to the narrow I/O bandwidth 434 allocated to the lower priority VDI workload at VE 172₉₈₇. Virtualized entities can be migrated to one or another node based on measured or predicted I/O bandwidth availability at the corresponding one or another node.

Further details regarding general approaches to predicting I/O bandwidth availability are described in U.S. patent application Ser. No. 15/283,004 titled “DYNAMIC RESOURCE DISTRIBUTION USING PERIODICITY-AWARE PREDICTIVE MODELING” filed on Sep. 30, 2016, which is hereby incorporated by reference in its entirety.

FIG. 4D presents a workload analysis technique 4D00 as implemented in systems for distributed resource allocation using dynamically classified workloads. As an option, one or more variations of workload analysis technique 4D00 or any aspect thereof may be implemented in the context of the architecture and functionality of the embodiments described herein. The workload analysis technique 4D00 or any aspect thereof may be implemented in any environment.

As illustrated in FIG. 4D, the herein disclosed techniques can be implemented to determine workload parameters for workloads running on virtualized entities in a distributed virtualization system (operation 1685). For example, and as shown, workload parameters can be determined for certain workloads running on node 252₇₆. The workload types from the workload parameters pertaining to the representative workloads at node 252₇₆ are also shown. Specifically, a SQL server workload and a VDI workload is detected to be running on node 252₇₆.

Using the workload parameters for the aforementioned workloads determined by the herein disclosed techniques, various workload-based resource allocation operations can be generated (operation 180₅). As one example of workload-based resource allocation operations, the workload parameters can be used to present various metrics pertaining to the resource capacity for serving the workloads (operation 412). For example, a view 442 might be presented in a user interface to analyze resources in a distributed virtualization system expressed in terms of the workloads detected in the system. More specifically, view 442 shows an overall future resource capacity runway of 80 days, constrained by the SQL server workload. The view 442 also shows the VDI workload has a future timeframe runway of 365 days.

Since the 80-day runway is below the “Target” (e.g., 180 days), some action is expected to be taken to remediate the deficiencies (operation 414). For example, as shown in view 444, a recommended allocation to remediate the below-target runway is to migrate one or more SQL server workloads to node 56. The user interacting with view 444 can either accept the recommended action by clicking the “Go” button, or decline the recommended action by clicking the “Ignore” button. In addition to the aforementioned actions to remediate the deficiencies (operation 414) some embodiments recommend specific models, and/or automatically order specific hardware and/or software so as to provide additional future capacity pertaining to the workloads.

### Additional Embodiments of the Disclosure

### Additional Practical Application Examples

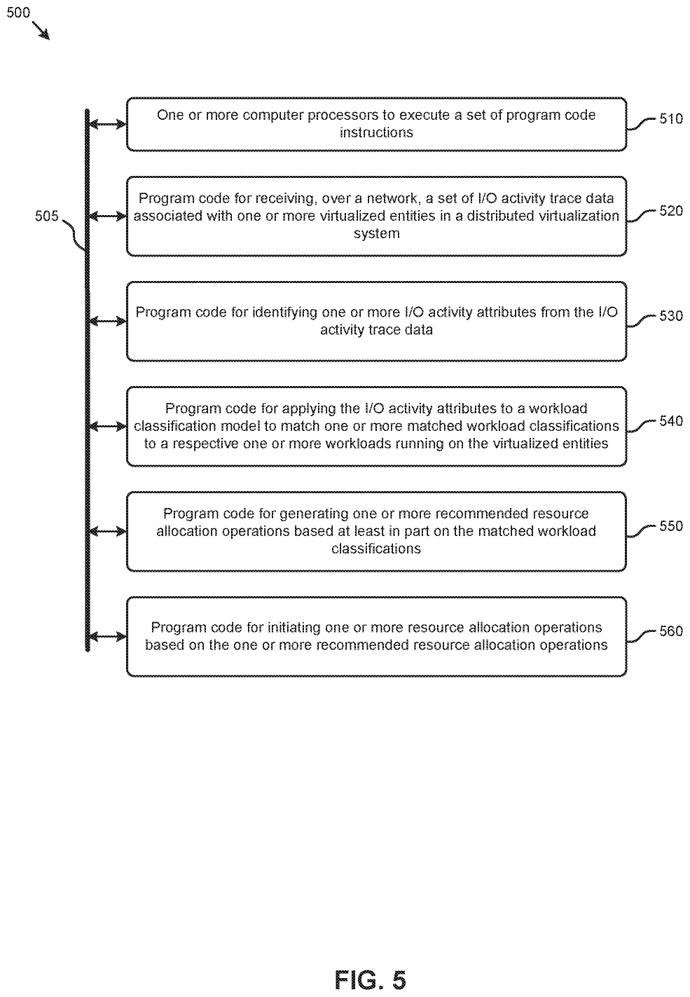

FIG. 5 depicts a system 500 as an arrangement of computing modules that are interconnected so as to operate cooperatively to implement certain of the herein-disclosed embodiments. This and other embodiments present particular arrangements of elements that individually, and/or as combined, serve to form improved technological processes that account for workload-based constraints when dynamically allocating resources in a distributed virtualization system. The partitioning of system 500 is merely illustrative and other partitions are possible. As an option, the system 500 may be implemented in the context of the architecture and functionality of the embodiments described herein. Of course, however, the system 500 or any operation therein may be carried out in any desired environment.

The system 500 comprises at least one processor and at least one memory, the memory serving to store program instructions corresponding to the operations of the system. As shown, an operation can be implemented in whole or in part using program instructions accessible by a module. The modules are connected to a communication path 505, and any operation can communicate with other operations over communication path 505. The modules of the system can, individually or in combination, perform method operations within system 500. Any operations performed within system 500 may be performed in any order unless as may be specified in the claims.

The shown embodiment implements a portion of a computer system, presented as system 500, comprising a computer processor to execute a set of program code instructions (module 510) and modules for accessing memory to hold program code instructions to perform: receiving, over a network, a set of I/O activity trace data associated with one or more virtualized entities in a distributed virtualization system (module 520); identifying one or more I/O activity attributes from the I/O activity trace data (module 530); applying the I/O activity attributes to a workload classification model to match one or more matched workload classifications to a respective one or more workloads running on the virtualized entities (module 540); generating one or more recommended resource allocation operations based at least in part on the matched workload classifications (module 550); and initiating one or more resource allocation operations based the one or more recommended resource allocation operations (module 560).

Variations of the foregoing may include more or fewer of the shown modules, and variations may perform more or fewer (or different) steps, and/or may use data elements in more or in fewer (or different) operations.

Still further, some embodiments include variations in the operations performed, and some embodiments include variations of aspects of the data elements used in the operations.

Some embodiments further comprise, receiving a set of observed workload type identifiers corresponding to a respective one or more observed workloads running on the virtualized entities; and generating a workload detection model to comprise one or more relationships between the I/O activity trace data and a workload.

Some embodiments further comprise initiating one or more resource allocation operations based on the one or more recommended resource allocation operations.

In some embodiments, the resource allocation operations comprise a workload migration from a first node to a second node.

In some embodiments, performing the one or more resource allocation operations is initiated automatically.

Some embodiments further comprise presenting at least one of the recommended resource allocation operations at a user interface to one or more users.

In some embodiments, the one or more recommended resource allocation operations includes determining when a migration is blocked.

In some embodiments, the one or more recommended resource allocation operations includes determining when a migration is blocked.

In some embodiments, the one or more recommended resource allocation operations includes determining bandwidth availability at a target node.

In some embodiments, individual measurements of the I/O activity trace data are associated with respective virtualized entities.

In some embodiments, the I/O activity attributes describe at least one of, a random access, a sequential access, a block size, a first number of read accesses, and/or a second number of write accesses.

### System Architecture Overview

### Additional System Architecture Examples

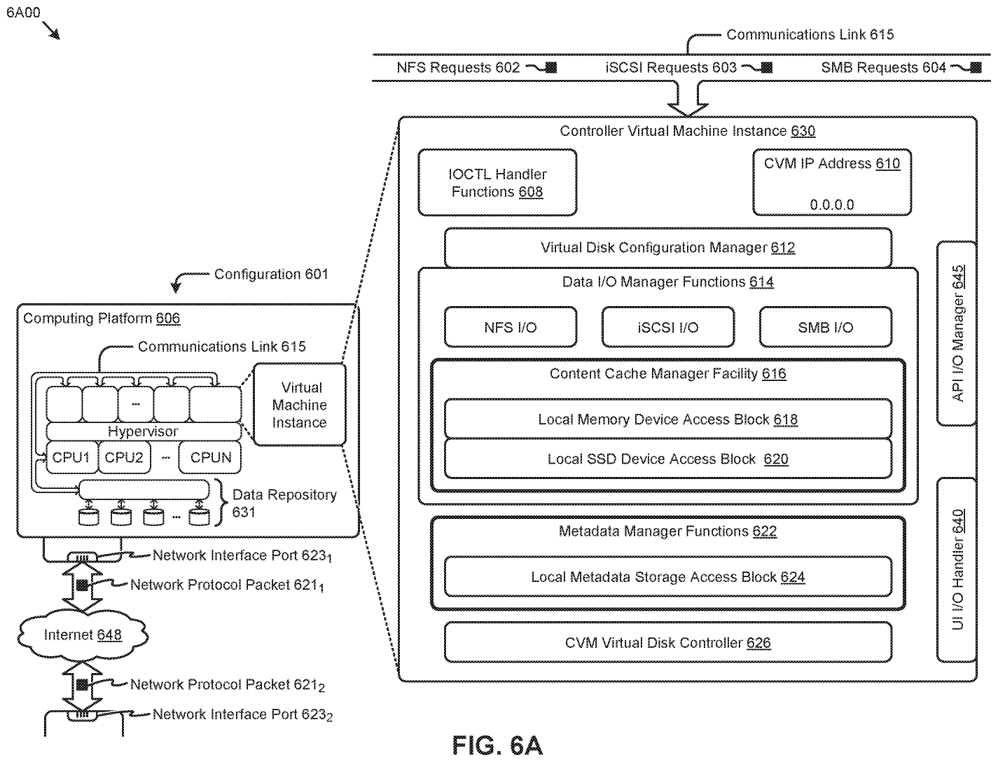

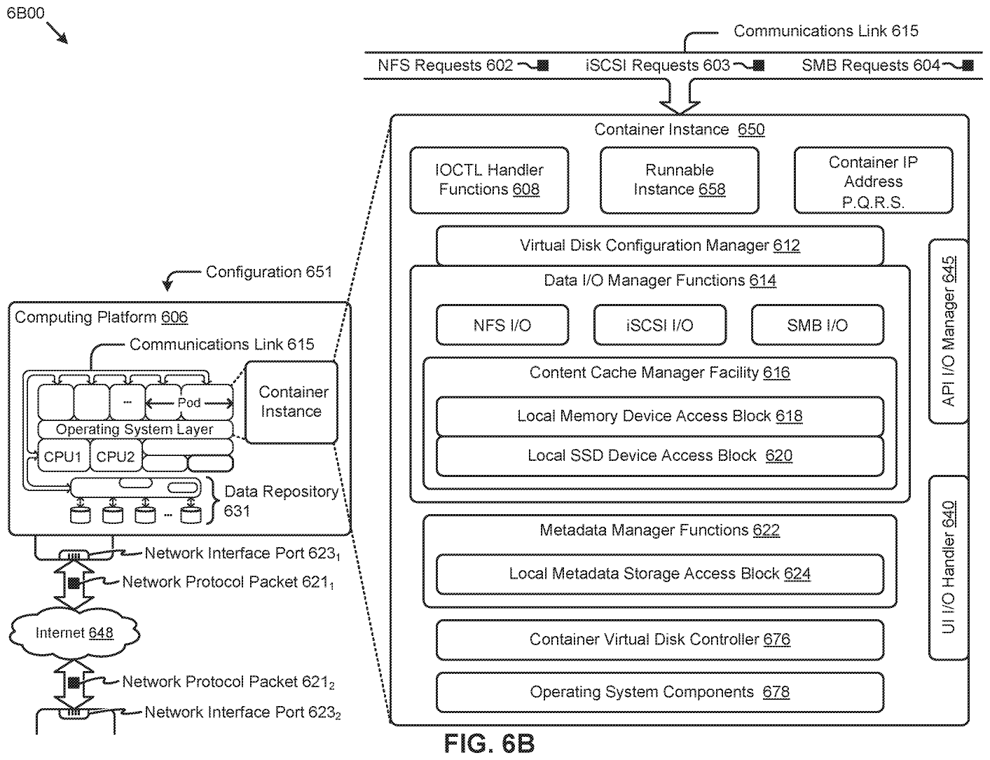

FIG. 6A depicts a virtualized controller as implemented by the shown virtual machine architecture 6A00. The heretofore-disclosed embodiments including variations of any virtualized controllers can be implemented in distributed systems where a plurality of networked-connected devices communicate and coordinate actions using inter-component messaging. Distributed systems are systems of interconnected components that are designed for or dedicated to storage operations as well as being designed for, or dedicated to, computing and/or networking operations. Interconnected components in a distributed system can operate cooperatively so as to serve a particular objective, such as to provide high-performance computing, high-performance networking capabilities, and/or high performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates efficient use of compute and storage resources by and between the components of the distributed system. Adding a hyperconverged unit to a hyperconverged system expands the system in multiple dimensions. As an example, adding a hyperconverged unit to a hyperconverged system can expand in the dimension of storage capacity while concurrently expanding in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as containers. In some systems and/or environments, hypervisor-assisted virtualization techniques and operating system virtualization techniques are combined.

As shown, the virtual machine architecture 6A00 comprises a collection of interconnected components suitable for implementing embodiments of the present disclosure and/or for use in the herein-described environments. Moreover, the shown virtual machine architecture 6A00 includes a virtual machine instance in a configuration 601 that is further described as pertaining to the controller virtual machine instance 630. A controller virtual machine instance receives block I/O (input/output or IO) storage requests as network file system (NFS) requests in the form of NFS requests 602, and/or internet small computer storage interface (iSCSI) block IO requests in the form of iSCSI requests 603, and/or Samba file system (SMB) requests in the form of SMB requests 604. The controller virtual machine (CVM) instance publishes and responds to an internet protocol (IP) address (e.g., CVM IP address 610). Various forms of input and output (I/O or IO) can be handled by one or more IO control handler functions (e.g., IOCTL functions 608) that interface to other functions such as data IO manager functions 614 and/or metadata manager functions 622. As shown, the data IO manager functions can include communication with a virtual disk configuration manager 612 and/or can include direct or indirect communication with any of various block IO functions (e.g., NFS IO, iSCSI IO, SMB IO, etc.).

In addition to block IO functions, the configuration 601 supports IO of any form (e.g., block IO, streaming IO, packet-based IO, HTTP traffic, etc.) through either or both of a user interface (UI) handler such as UI IO handler 640 and/or through any of a range of application programming interfaces (APIs), possibly through the shown API IO manager 645.

The communications link 615 can be configured to transmit (e.g., send, receive, signal, etc.) any types of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases the payload comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as a random access memory. As shown, the controller virtual machine instance 630 includes a content cache manager facility 616 that accesses storage locations, possibly including local dynamic random access memory (DRAM) (e.g., through the local memory device access block 618) and/or possibly including accesses to local solid state storage (e.g., through local SSD device access block 620).

Common forms of computer readable media includes any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 631, which in turn can be formatted into any one or more storage areas, and which can comprise parameterized storage accessible by a key (e.g., a filename, a table name, a block address, an offset address, etc.). An external data repository 631 can store any forms of data, and may comprise a storage area dedicated to storage of metadata pertaining to the stored forms of data. In some cases, metadata, can be divided into portions. Such portions and/or cache copies can be stored in the external storage data repository and/or in a local storage area (e.g., in local DRAM areas and/or in local SSD areas). Such local storage can be accessed using functions provided by a local metadata storage access block 624. The external data repository 631 can be configured using a CVM virtual disk controller 626, which can in turn manage any number or any configuration of virtual disks.

Execution of the sequences of instructions to practice certain embodiments of the disclosure are performed by a one or more instances of a software instruction processor, or a processing element such as a data processor, or such as a central processing unit (e.g., CPU1, CPU2). According to certain embodiments of the disclosure, two or more instances of a configuration 601 can be coupled by a communications link 615 (e.g., backplane, LAN, PSTN, wired or wireless network, etc.) and each instance may perform respective portions of sequences of instructions as may be required to practice embodiments of the disclosure.

The shown computing platform 606 is interconnected to the Internet 648 through one or more network interface ports (e.g., network interface port 623₁ and network interface port 623₂). The configuration 601 can be addressed through one or more network interface ports using an IP address. Any operational element within computing platform 606 can perform sending and receiving operations using any of a range of network protocols, possibly including network protocols that send and receive packets (e.g., network protocol packet 621₁ and network protocol packet 621₂).

The computing platform 606 may transmit and receive messages that can be composed of configuration data, and/or any other forms of data and/or instructions organized into a data structure (e.g., communications packets). In some cases, the data structure includes program code instructions (e.g., application code) communicated through Internet 648 and/or through any one or more instances of communications link 615. Received program code may be processed and/or executed by a CPU as it is received and/or program code may be stored in any volatile or non-volatile storage for later execution. Program code can be transmitted via an upload (e.g., an upload from an access device over the Internet 648 to computing platform 606). Further, program code and/or results of executing program code can be delivered to a particular user via a download (e.g., a download from the computing platform 606 over the Internet 648 to an access device).

The configuration 601 is merely one sample configuration. Other configurations or partitions can include further data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A cluster is often embodied as a collection of computing nodes that can communicate between each other through a local area network (e.g., LAN or VLAN) or a backplane. Some clusters are characterized by assignment of a particular set of the aforementioned computing nodes to access a shared storage facility that is also configured to communicate over the local area network or backplane. In many cases, the physical bounds of a cluster is defined by a mechanical structure such as a cabinet or chassis or rack that hosts a finite number of mounted-in computing units. A computing unit in a rack can take on a role as a server, or as a storage unit, or as a networking unit, or any combination therefrom. In some cases a unit in a rack is dedicated to provision of power to the other units. In some cases a unit in a rack is dedicated to environmental conditioning functions such as filtering and movement of air through the rack, and/or temperature control for the rack. Racks can be combined to form larger clusters. For example, the LAN of a first rack having 32 computing nodes can be interfaced with the LAN of a second rack having 16 nodes to form a two-rack cluster of 48 nodes. The former two LANs can be configured as subnets, or can be configured as one VLAN. Multiple clusters can communicate between one another over a WAN (e.g., when geographically distal) or LAN (e.g., when geographically proximal).

A module as used herein can be implemented using any mix of any portions of the system memory and any extent of hard-wired circuitry including hard-wired circuitry embodied as a data processor. Some embodiments of a module include one or more special-purpose hardware components (e.g., power control, logic, sensors, transducers, etc.). Some embodiments of a module include instructions that are stored in a memory for execution so as to implement algorithms that facilitate operational and/or performance characteristics pertaining to making distributed resource allocation decisions using dynamically classified workloads. In some embodiments, a module may include one or more state machines and/or combinational logic used to implement or facilitate the operational and/or performance characteristics pertaining to making distributed resource allocation decisions using dynamically classified workloads.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of performing distributed resource allocation using dynamically classified workloads). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to making decisions pertaining to distributed resource allocations when using dynamically classified workloads, and/or for improving the way data is manipulated when performing computerized operations pertaining to implementing a workload detection and classification model to dynamically classify workloads.

Further details regarding general approaches to managing data repositories are described in U.S. Pat. No. 8,601,473 titled, “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled, “METHOD AND SYSTEM FOR IMPLEMENTING MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 6B depicts a virtualized controller implemented by a containerized architecture 6B00. The containerized architecture comprises a collection of interconnected components suitable for implementing embodiments of the present disclosure and/or for use in the herein-described environments. Moreover, the shown containerized architecture 6B00 includes a container instance in a configuration 651 that is further described as pertaining to the container instance 650. The configuration 651 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any container (e.g., container instance 650). A container instance can be executed by a processor. Runnable portions of a container instance sometimes derive from a container image, which in turn might include all, or portions of any of, a Java archive repository (JAR) and/or its contents, and/or a script or scripts and/or a directory of scripts, and/or a virtual machine configuration, and may include any dependencies therefrom. In some cases a configuration within a container might include an image comprising a minimum set of runnable code. Contents of larger libraries and/or code or data that would not be accessed during runtime of the container instance can be omitted from the larger library to form a smaller library composed of only the code or data that would be accessed during runtime of the container instance. In some cases, start-up time for a container instance can be much faster than start-up time for a virtual machine instance, at least inasmuch as the container image might be much smaller than a respective virtual machine instance. Furthermore, start-up time for a container instance can be much faster than start-up time for a virtual machine instance, at least inasmuch as the container image might have many fewer code and/or data initialization steps to perform than a respective virtual machine instance.

A container instance (e.g., a Docker container) can serve as an instance of an application container. Any container of any sort can be rooted in a directory system, and can be configured to be accessed by file system commands (e.g., “ls” or “ls-a”, etc.). The container might optionally include operating system components 678, however such a separate set of operating system components need not be provided. As an alternative, a container can include a runnable instance 658, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, a container virtual disk controller 676. Such a container virtual disk controller can perform any of the functions that the aforementioned CVM virtual disk controller 626 can perform, yet such a container virtual disk controller does not rely on a hypervisor or any particular operating system so as to perform its range of functions.

In some environments multiple containers can be collocated and/or can share one or more contexts. For example, multiple containers that share access to a virtual disk can be assembled into a pod (e.g., a Kubernetes pod). Pods provide sharing mechanisms (e.g., when multiple containers are amalgamated into the scope of a pod) as well as isolation mechanisms (e.g., such that the namespace scope of one pod does not share the namespace scope of another pod).

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method comprising:
receiving a set of I/O activity trace data corresponding to a virtualized entity executing a workload on a computing system;
identifying a set of I/O activity attributes from a set of I/O activity trace data;
determining a type of the workload based on a correlation between the identified set of I/O activity attributes and I/O activity attributes of a workload classification model;
generating a recommended resource allocation operation based at least in part on the determined type of the workload; and
initiating a resource allocation operation based at least in part on the recommended resource allocation operation.

2. The method of claim 1, wherein the workload is associated with correlation weights of a corresponding workload type identifier.

3. The method of claim 1, wherein the workload is associated with correlation weights and the correlation weights are based at least in part on the set of I/O activity attributes of the set of I/O activity trace data.

4. The method of claim 1, wherein the resource allocation operation comprises a workload migration from a first node to a second node.

5. The method of claim 1, wherein the resource allocation operation comprises a workload migration from a first cluster to a second cluster.

6. The computer readable medium of claim 11, wherein performing the resource allocation operation is initiated automatically.

7. The computer readable medium of claim 11, further comprising presenting at least two recommended resource allocation operations at a user interface.

8. The computer readable medium of claim 11, wherein the recommended resource allocation operation is based on a determination that a migration is blocked.

9. The computer readable medium of claim 11, wherein the recommended resource allocation operation are based on at least an affinity to a workload type.

10. The computer readable medium of claim 11, wherein the set of I/O activity attributes describe at least one of, a random access, a sequential access, a block size, a first number of read accesses, or a second number of write accesses.

11. A non-transitory computer readable medium having stored thereon a sequence of instructions which, when executed by a processor performs a set of acts comprising:
receiving a set of I/O activity trace data corresponding to a virtualized entity executing a workload on a computing system;
identifying a set of I/O activity attributes from a set of I/O activity trace data;
determining a type of the workload based on a correlation between the identified set of I/O activity attributes and I/O activity attributes of a workload classification model;
generating a recommended resource allocation operation based at least in part on the determined type of the workload; and
initiating a resource allocation operation based at least in part on the recommended resource allocation operation.

12. The computer readable medium of claim 11, wherein the workload is associated with correlation weights of a corresponding workload type identifier.

13. The computer readable medium of claim 11, wherein the workload is associated with correlation weights and the correlation weights are based at least in part on the set of I/O activity attributes of the set of I/O activity trace data.

14. The computer readable medium of claim 11, wherein the resource allocation operation comprises a workload migration from a first node to a second node.

15. The computer readable medium of claim 11, wherein the resource allocation operation comprises a workload migration from a first cluster to a second cluster.

16. A system comprising:
a storage medium having stored thereon a sequence of instructions; and
a processor that executes the sequence of instructions to perform a set of acts comprising:
receiving a set of I/O activity trace data corresponding to a virtualized entity executing a workload on a computing system;
identifying a set of I/O activity attributes from a set of I/O activity trace data;
determining a type of the workload based on a correlation between the identified set of I/O activity attributes and I/O activity attributes of a workload classification model;
generating a recommended resource allocation operation based at least in part on the determined type of the workload; and
initiating a resource allocation operation based at least in part on the recommended resource allocation operation.

17. The system of claim 16, wherein the resource allocation operation comprises a workload migration from a first node to a second node.

18. The system of claim 16, wherein the resource allocation operation comprises a workload migration from a first cluster to a second cluster.

19. The system of claim 16, wherein performing the resource allocation operation is initiated automatically.

20. The system of claim 16, wherein the recommended resource allocation operation are based on at least an affinity to a workload type.

21. A non-transitory computer readable medium having stored thereon a sequence of instructions which, when executed by a processor performs a set of acts comprising:
receiving a set of I/O activity trace data corresponding to a virtualized entity executing a workload on a computing system;
identifying a set of I/O activity attributes from a set of I/O activity trace data;
training a workload model with a first portion of the set of I/O activity attributes;
validating training of the workload model by correlating a workload type for the workload corresponding to the first portion of the set of I/O activity attributes and a second portion of the set of I/O activity attributes;
determining a type of the workload using the workload model based; and
generating a recommended resource allocation operation based at least in part on the determined type of the workload.

22. The computer readable medium of claim 21, wherein the workload is associated with correlation weights of a corresponding workload type identifier.

23. The computer readable medium of claim 21, wherein the workload is associated with correlation weights and the correlation weights are based at least in part on the set of I/O activity attributes of the set of I/O activity trace data.
